(19) United States
(12) Patent Application Publication
(10) Pub. No.: US 2023/0292714 A1
(43) Pub. Date: Sep. 21, 2023

(54) DEVICE FOR RUNNING A LEASHED PET

(71) Applicants: Joshua John Muscat, Placerville, CA (US); Narendhar Mohanasundram, Singapore (SG)

(72) Inventors: Joshua John Muscat, Placerville, CA (US); Narendhar Mohanasundram, Singapore (SG)

(21) Appl. No.: 18/121,182

(22) Filed: Mar. 14, 2023

Related U.S. Application Data
(60) Provisional application No. 63/320,262, filed on Mar. 16, 2022.

(51) Int. Cl. A01K 27/00

(52) U.S. Cl. CPC A01K 27/003

(57) ABSTRACT

A device comprising a cord, a pair of handles, a cord guide assembly and an attachment mechanism. The cord has an elongated cord body and a loop disposed at each end. The handle is coupled to each of the loop which is slidable along a distal part of an angular portion of the handle in response to a movement of the handle or of the loop. The cord guide assembly has a pulley mechanism comprising a pulley configured to ride on the elongated cord body to enable a sliding back and forth motion of the elongated cord body across the pulley. The attachment mechanism is configured to releasably receive a ring of the cord guide assembly and a portion of a leash. The sliding motions enable the portion of the leash to remain steady relative to the handles.

### REFERENCE TO RELATED APPLICATIONS

This application claims the benefit of U.S. Provisional Application No. 63/320,262, filed Mar. 16, 2022, the contents of which are incorporated herein by reference.

### FIELD OF THE INVENTION

The present invention relates generally to pet restraining devices. More specifically, the present invention pertains to a device for running or training dogs.

### BACKGROUND OF THE INVENTION

Some pets, particularly dogs, should be given the opportunity to regularly engage in physical activities for their good health. Running is an excellent form of physical activity and most of the dog breeds love it. But, running is an activity which can be done in its true sense at outdoors only and, when outside a confined area, a pet cannot be entirely set free. Generally, to control or restrain movements of a pet, a leash is attached to a collar put around the neck of the pet. Many people love to run with their dogs as besides being a great way to exercise such shared experience helps in building a stronger bond between the dog and its handler. A dog, especially a dog of larger breed, can exert considerable pull on the leash, and to control and restrain such a dog with one hand while running can be a very challenging task. Leashes adapted to be held by only one hand strain the muscles and cause discomfort to the handler. So, if the pulling force is shared equally by both the hands then it becomes relatively easier for the handler to restrain the dog. But, as the arms of the handler swing during running, it becomes almost impossible for the handler to not get hindered by the variable forces that act on the leash due to the swinging arms and inconsistent direction of travel and speed of the running dog. As a result, the handlers are compelled to adopt an uncomfortable running stance which adversely affects their running experience with their pet dogs.

Traditional dog leashes either do not have dual handles/loops for holding the leash by both the hands or they do not allow the handler to move both hands freely while having comfortable stride and yet having full control over the pet dog. Thus, there exists a need for a device which can overcome the aforementioned issues involved with running or walking dog on leash.

### OBJECTS OF THE INVENTION

An object of the present invention is to provide a device which enables a handler to run or walk with a pet on leash without adversely affecting the handler’s natural gait and the pet’s movements.

Another object of the present invention is to provide a device which enables a handler and his/her pet on leash to run in tandem.

Still another object of the present invention is to provide a device that can be used with a conventional leash.

Another object of the present invention is to provide a device that enables a handler to hold a leash by one hand or by both hands, as required.

Yet another object of the present invention is to provide a device with adjustable length for attaching to a leash.

Another object of the present invention is to provide a device that enables a person to handle multiple pets on leash.

Yet another object of the present invention is to provide a device which mitigates stress and strain that get created on handler’s arms due to handling of a pet on leash.

Still another object of the present invention is to provide device that enables a handler to have complete control over a running pet on leash.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The device or apparatus of the present invention is adapted to be used with a conventional pet leash. To obviate generation of excessive pulling/resistive forces and to let the handler and the pet on leash run together as naturally as possible the leash should be allowed to stay at a position where it is least stressed. Present invention lets this happen with minimal resistance even when the handler’s arms holding the handles connected to the leash swing. The device comprises a cord, a pair of handles, a cord guide assembly and an attachment mechanism. The cord has a resilient elongated cord body with a loop defined on each end of the elongated cord body. Each handle is configured to be slidably coupled to a loop. A pulley of the cord guide mechanism allows the elongated cord body to pass around the cord guide mechanism. The attachment mechanism flexibly and removably connects the cord guide mechanism to a part of a leash. The device can be used by either holding each of the handles with one hand or by holding both the handles together with one hand. A user holding a handle in each hand can still swing his/her arms normally while maintaining a firm control over a pet on leash running with him/her. As the arms swing, the elongated cord body passes through the pulley and the loops slide along the handles, all with minimal resistance, to maintain the connected leash end as steady as possible with respect to the user during all the stages of the arm movements. If the leash end is not overly pulled along during the arm swings and the relative position is not disturbed, as accomplished by the device of the present invention, then the arms feel less fluctuation of forces. Even distribution of the forces transmitted through the leash between the hands enables a user to restrain a strong or unruly pet without getting his/her hand muscles strained. Elongation and contraction of the elongated cord body dampen the shocks generated by the sudden pulls or tugs exerted by the pet. Multiple flexible couplings provided by the device between the leash end and the handles allow the pet on leash to run or walk side by side without requiring the handler to change grip or orientation of the handles. Even when the handles are attached and held together by a single hand the device still maintains the connected leash end steady and offers the same freedom of having natural arm movements while walking/running with a pet. If required, the attachment mechanism can directly connect the handles to the leash end to bring the pet closer to the user and to circumvent the flexibility offered by the cord.

### BRIEF DESCRIPTION OF DRAWINGS

The accompanying drawings, which are incorporated herein and form a part of the specification, illustrate the present invention and, together with the description, further serve to explain the principles of the invention and to enable a person skilled in the relevant art to make and use the invention. The present invention will become more fully understood from the detailed description given herein below and the accompanying drawings which are given by way of illustration only, and thus are not limitative of the present invention, and wherein:

FIG. 1 illustrates a front perspective view of the device for running with a pet on leash in accordance with an embodiment of the present invention;

FIG. 2A shows a front view of a cord of the device for running with a pet on leash in accordance with an embodiment of the present invention;

FIG. 2B illustrates a front view of a handle of the device for running with a pet on leash in accordance with an embodiment of the present invention;

FIG. 2C illustrates a front view of a cord guide assembly and an attachment mechanism of the device for running with a pet on leash in accordance with an embodiment of the present invention;

FIG. 3 illustrates a front perspective view of the device engaged to a leash in accordance with an embodiment of the present invention;

FIG. 4 illustrates an exemplary use of the device for running with a pet on leash in accordance with an embodiment of the present invention;

FIG. 5 illustrates a view of the device maintaining the connected leash end substantially steady during swinging motion of the user’s arms in an exemplary running gait;

FIG. 6A illustrates a front perspective view of the device engaged to a leash with the handles being held together with one hand of the user in accordance with an exemplary use case of the present invention;

FIG. 6B illustrates another front perspective view of the device engaged to a leash with the handles being held together with one hand of the user in accordance with an exemplary use case of the present invention; and

FIG. 7 illustrates a front perspective view of the device with the attachment mechanism directly coupling the handles to a leash bypassing the cord in accordance with an exemplary use case of the present invention;

FIG. 8 illustrates a second embodiment of the attachment mechanism of the device;

FIG. 9 illustrates a third embodiment of the attachment mechanism with a third embodiment of the cord guide assembly of the device;

FIG. 10A illustrates a second embodiment of the cord guide assembly of the device;

FIG. 10B illustrates a third embodiment of the cord guide assembly of the device;

FIG. 11 illustrates second embodiment of the attachment mechanism attached to the second embodiment of the cord guide assembly;

FIG. 12 illustrates a front perspective view of the device engaged to a leash, the device using the second embodiment of the attachment mechanism and the second embodiment of the cord guide assembly;

FIG. 13 illustrates a front perspective view of the device engaged to a leash, the device using the third embodiment of the attachment mechanism and the third embodiment of the cord guide assembly;

FIG. 14 illustrates a front perspective view of the device with the second embodiment of the attachment mechanism directly coupling the handles to a leash bypassing the cord; and

FIG. 15 illustrates a front perspective view of the device with the third embodiment of the attachment mechanism directly coupling the handles to a leash bypassing the cord.

### DETAILED DESCRIPTION OF THE INVENTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

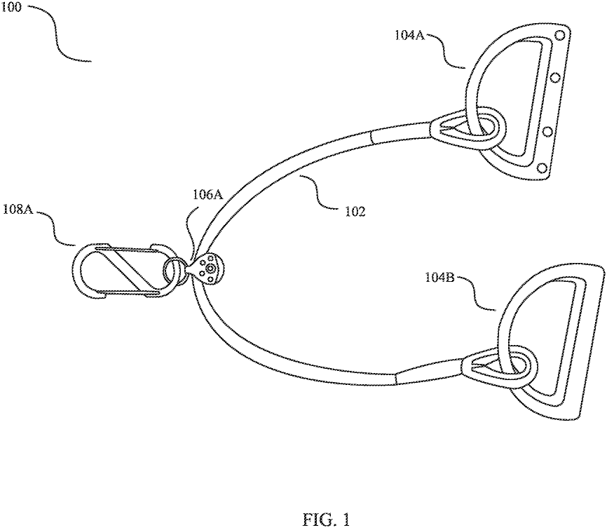

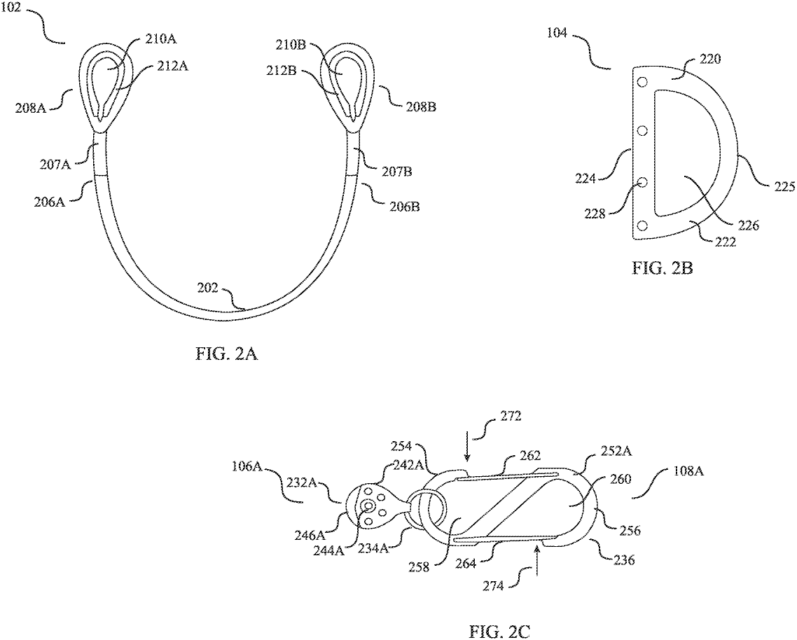

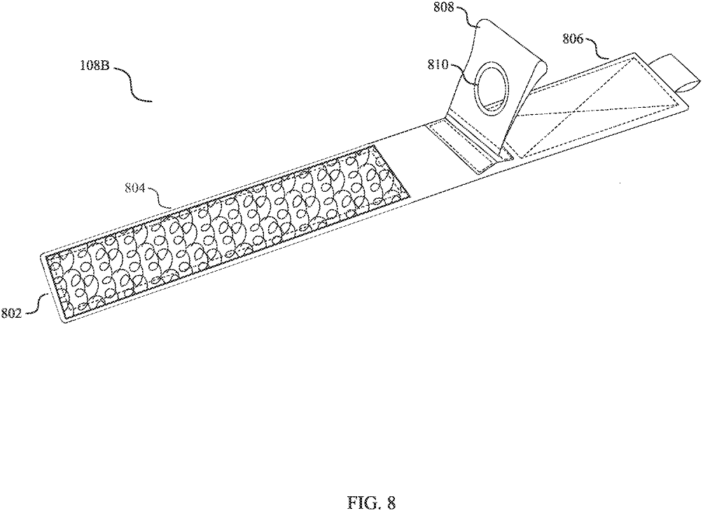

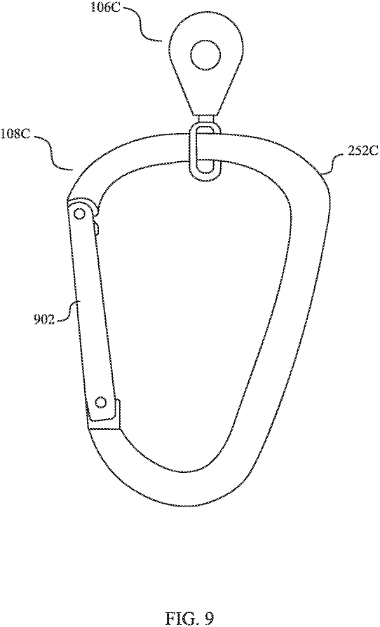

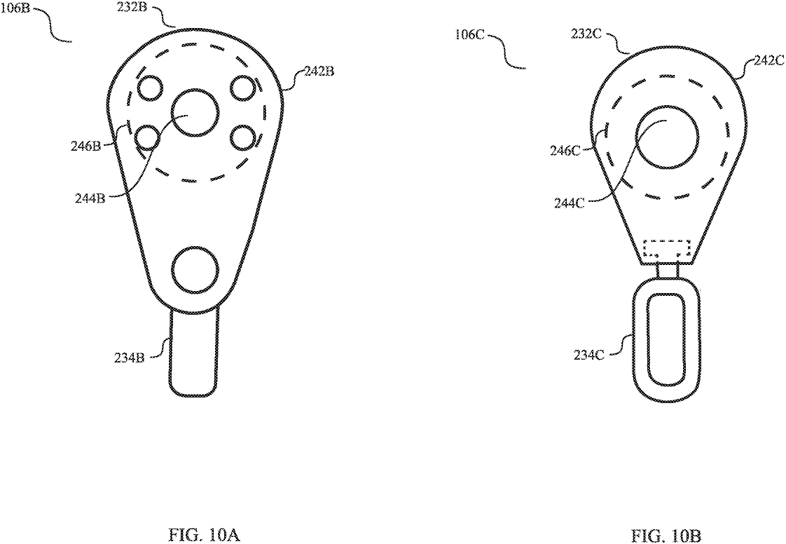

Reference to FIG. 1, the device 100 for leashing a running pet comprises a cord 102, at least one pair of handles/hand engaging members 104A and 104B, a cord guide assembly/engagement mechanism 106A (106B in FIGS. 10A or 106C in FIG. 10B) and an attachment mechanism 108A (108B in FIGS. 8 or 108C in FIG. 9). As shown in FIG. 2A, the cord 102 comprises an elongated cord body 202 with spaced ends 206A and 206B having a length therebetween and a loop 208 (208A or 208B) disposed on each end 206A and 206B. In some embodiments, the loops 208A and 208B having loop openings 210A and 210B respectively are formed by attaching the ends 206A and 206B back to themselves with the help of sleeves 207A and 207B respectively. Thimbles 212A and 212B can be used to reinforce the loops 208A and 208B respectively. Sleeves 207A and 207B can be plastically deformed, i.e. squeezed together or crimped to secure the ends. As an alternative to sleeves, knots or sewn connections can be used. In some embodiments, the loops 208A and 208B can be additional connectors such as rings (not shown in the drawings) attached to the ends 206A and 206B.

In a preferred embodiment, the elongated cord body 202 may be formed of elastic material such as rubber, or fabric-covered rubber, polyvinyl chloride tubing, thermoplastic polyurethane tubing, bungee cord which will elongate and concurrently impart resistance to such elongation. Being substantially elastic in nature, in this embodiment, the elongated cord body 202 can absorb shock and diffuse tension created in the cord 102 due to any difference in pulling forces. In some embodiments, the elongated cord body 202 may be formed of non-elastic material (rope, cable etc., for example).

In general, the length of the elongated cord body 202 is so dimensioned that the user i.e. the handler while running and using the device 100 has a full, comfortable range of arm motion/swings under nominal resistance without the elongated cord body 202 reaching its maximum stretch point so that the elongated cord body 202 can absorb the variations in pull exerted on the leash by a pet dog running at uneven speed or the pet dog running out of sync with the handler. Increase in resistance against elongation of the elongated cord body 202 can overly stress the user’s arm muscles and disrupt the natural running stance of the user.

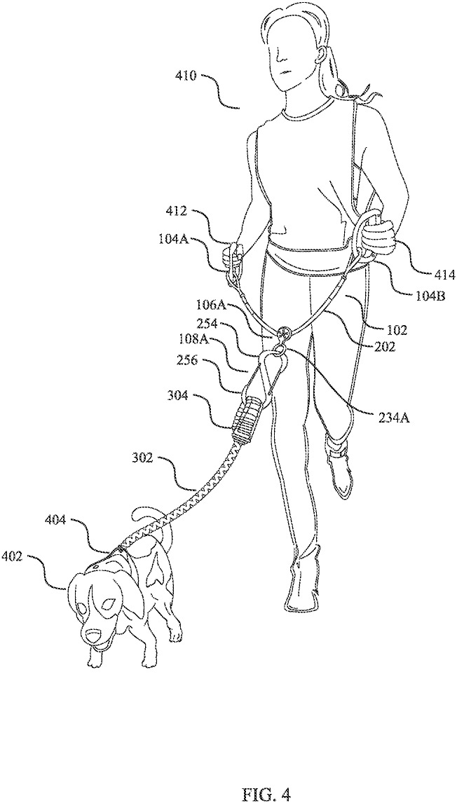

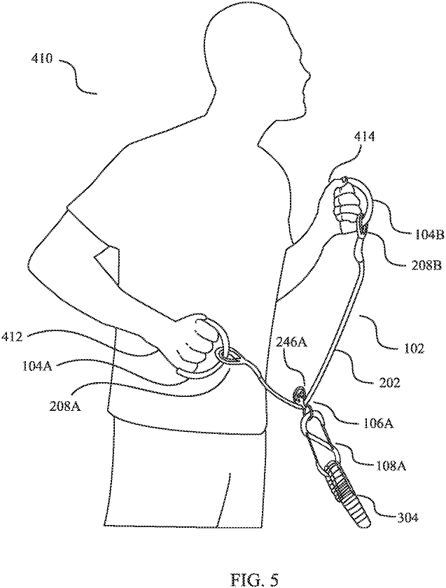

In the currently depicted embodiment, a handle body 220 of the handle (104A or 104B) defines a substantially “D” shaped form, as best seen in FIG. 2B, having an angular portion 222 extending from a graspable gripping portion 224 to enclose a handle opening 226. The gripping portion 224 is adapted to be easily grasped by the hand of a user as shown in FIGS. 4 and 5. It is understood that in alternate embodiments, various grip enhancements and pads can be provided on the gripping portion 224.

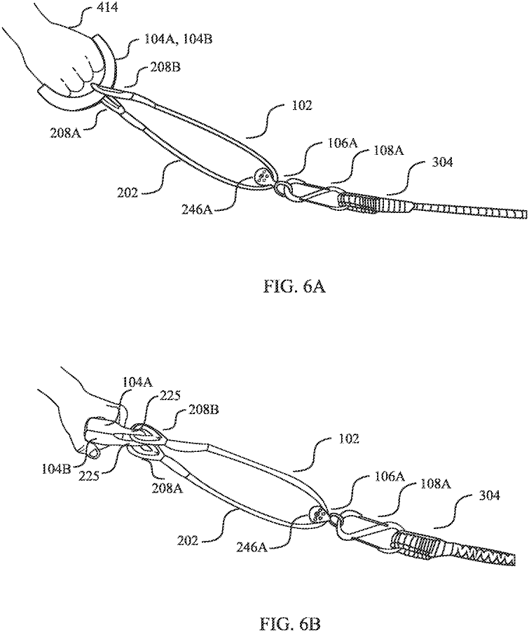

The angular portion 222 is received by the loop opening (210A or 210B) to slidably couple the handles 104A and 104B to the loops 208A and 208B respectively. In a preferred embodiment, as can be seen in FIG. 6B, the distal part 225 of the angular portion 222 has a cross-sectional area smaller than that of the rest of the angular portion 222, such that the loop (208A or 208B) cannot slide along the angular portion 222 beyond the distal part 225. In one embodiment, the sleeves 207A and 207B are configured to enable adjustment of the size of the loop openings 210A and 210B so that, if required, the loops 208A and 208B can firmly grip the handles 104A and 104B to offer tighter control over the pet on leash.

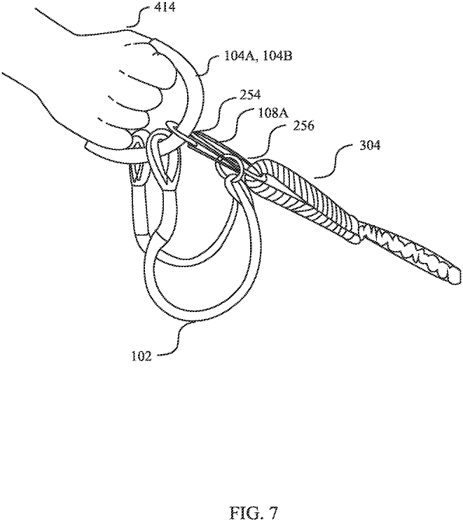

The handles 104, as shown in FIG. 2B, further comprise one or more fastening elements 228 disposed over the handle body 220 for removably attaching the handles 104A and 104B together as shown in FIGS. 6A, 6B and 7. Examples of fastening element 228 may comprise magnets and hook and loop fasteners etc. While only a D-shaped rigid handle 104 has been described here, it is to be understood that any other mechanism, such as, for example, a loop or an adjustable strap, that may provide a graspable body and also can rotatably secure the ring 234 may be utilized.

FIGS. 2C, 10A and 10B illustrate three embodiments of the cord guide assembly 106A, 106B and 106C respectively. All the three versions of the cord guide assembly comprise a pulley mechanism 232A/232B/232C and a ring 234A/234B/234C. The pulley mechanism 232A/232B/232C includes a pulley frame 242A/242B/242C, an axle 244A/244B/244C and a pulley 246A/246B/246C. The pulley frame 242A/242B/242C engages both sides of the axle 244A/244B/244C on which the pulley 246A/246B/246C is rotatably mounted. The pulley 246A/246B/246C has a circumferential groove adapted to receive at least a part of the cross-section of the elongated cord body 202 such that, while rotating about axle 244A/244B/244C, the pulley 246A/246B/246C may support the elongated cord body 202 to pass therearound without allowing the loops 208A and 208B or the handles 104 to pass through it. The pulley frame 242A/242B/242C is also configured to loosely receive the ring 234A/234B/234C. Even though, the ring 234A/234B is shown in the figures as being generally circular, it should be recognized that ring 234A/234B may assume other shapes, such as elliptical (as in FIG. 10B), triangular, D-shaped etc., for example. In some embodiments, the pulley frame 242A/242B/242C itself is configured to receive the attachment mechanism 108A/108B/108C or even the leash end 304 directly. Either way, the cord guide assembly 106A/106B/106C lets the elongated cord body 202 freely run through it and holds the leash end 304 directly or through the attachment mechanism 108A/108B/108C. As in the cord guide assembly 106C, the ring 234C can be swivelable with respect to the pulley frame 242A/242B/242C.

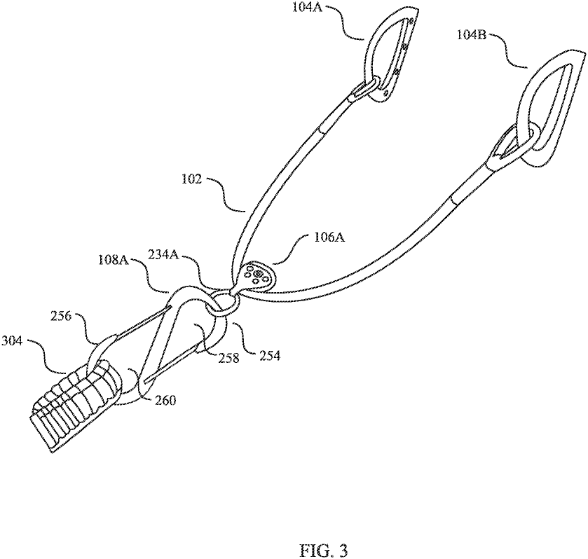

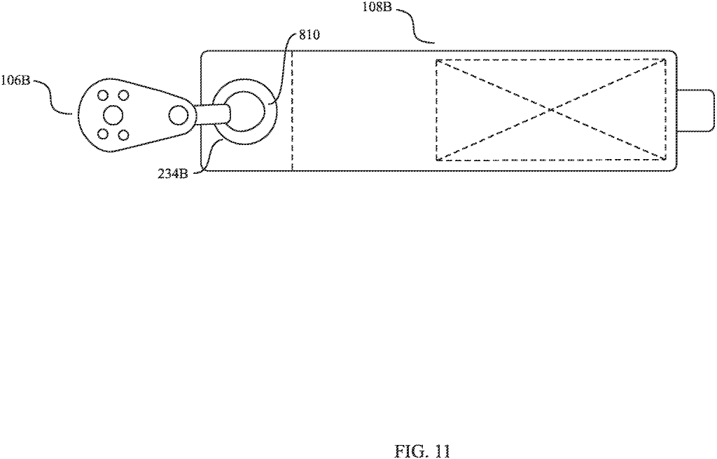

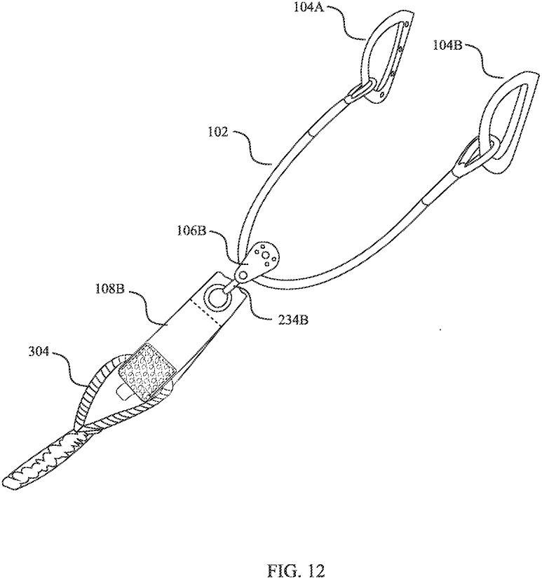

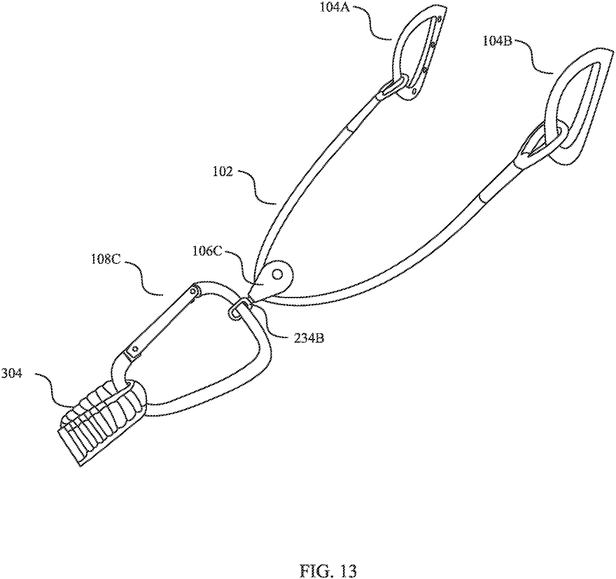

The attachment mechanism 108A, as shown in FIG. 2C, or the attachment mechanism 108B as shown in FIG. 8, or the attachment mechanism 108C as shown in FIG. 9, is shaped and sized to releasably receive and rotatably and slidably engage the ring 234A/234B/234C or the pulley frame 242A/242B/242C and a portion of a leash (leash end 304, for example). In one embodiment, as illustrated in FIG. 2C, the connector body 252A of the attachment mechanism 108A defines an S-shaped frame 236 having a proximal connector end 254 and distal connector end 256. Spring-loaded closure members - first closure member 262 and second closure member 264 are pivotally mounted to the connector body 252 and are biased toward the respective ends of the frame 236. Thus, closure members 262 and 264 cooperate with their associated segments of proximal connector end 254 and distal connector end 256 to form respective normally closed connector loops 258 and 260. Each closure member 262 and 264 can be pivoted inwardly against the spring force in the direction indicated by the arrows 272 and 274 to open their associated connector loops 258 and 260 respectively. In another embodiment, the attachment mechanism 108B of FIG. 8 comprises an elongated connector body 802 having a first part 804, a second part 806 opposite to the first part 804 and a tab 808 disposed therebetween. The first part 804 and the second part 806 are configured to be releasably attached to each other by way of hook and loop fastener or other types of snap fasteners so that the first part 804 and the second part 806 together form a closed loop and the tab 808 remains external to the loop. An aperture 810 configured to receive the ring 234A/234B is disposed in the tab 808. FIG. 3 shows ring 234A received by the connector loop 258 and leash end 304 received by the connector loop 260. In FIG. 11, the attachment mechanism 108B is shown attached to the cord guide assembly 106B. Whereas an S-carabiner or dual carabiner is described here as attachment mechanism 108A, it is to be understood that other types of shackles or connectors capable of quickly and reversibly connecting components can be used as the attachment mechanism 108A. For example, as illustrated in FIG. 9, the attachment mechanism 108C is a single loop carabiner. The connector body 252C has a spring-loaded closure member 902 pivotally mounted to the connector body 252C and is biased toward the frame 252C. FIG. 13 depicts the ring 234B and the leash end 304 received by the attachment mechanism 108C. FIG. 12 illustrates the same with attachment mechanism 108B holding the ring 234B and the leash end 304.

FIG. 4 depicts a user or handler 410 running with a pet dog 402. One end of a conventional leash 302 is shown connected to a collar 404 worn by the pet 402. The other end 304 of the leash 302 is secured to the distal connector end 256 of the device 100 of the present invention. The handles 104A and 104B are held by the two hands 412 and 414 of the user 410.

To have an unhindered and natural running/walking experience with a pet on leash it is essential that the handler feels as little pulling forces or as little variations in forces through the leash as possible. With the conventional leashing options, without the use of the device 100 of the present invention, both the pet and its handler experience a range of forces when they walk or run together. For example, a resistance is felt by the pet dog 402 and by the handler 410 if there is any difference in the pace/speed with which they are walking or running or if the pet dog 402 exerts a sudden pull or tug. Similarly, if the pet dog 402 does not walk or run straight ahead of the handler 410 or suddenly changes its direction of walk/run then the handler 410 feels a pulling force in a lateral direction. If the handler is holding the leash with just one hand, as is the case with most of the conventional leashes, the handler may get off balance when the pull is exerted sideways as the body of the handler does not get the opportunity to adequately adjust itself. Since, in case of the present invention, each hand of the handler holds a handle of the device, the sideways pull acts like a moment of force or torque on the body of the handler and the handler’s body twists about the central axis of itself to respond to the turning effect and, thus, remain stable. Again, a conventional leash 302, when used without the device 100 of the present invention, does not allow the handler 410 to swing his/her arm naturally without feeling the resistance offered by the leash.

With the use of the device 100 of the present invention, as shown in FIGS. 4 and 5, collar 404 and handles 104A and 104B are the end points or starting points for transmission of the aforementioned forces between the pet dog 402 and the handler 410. Since, each handle 104A and 104B can be held individually, the aforementioned forces get distributed between both the hands 412 and 414 of the handler 410. The elongated cord body 202 helps in maintaining the leash end 304 steady by resiliently getting elongated to accommodate any change in distance between the pet dog 402 and the handler 410 that may arise due to change in walking/running speed or due to sudden pulling or tugging by the pet dog 402.

Even in situations when the lines of travel of the pet dog 402 and the handler 410 are not aligned with each other, the device 100 of the present invention still lets the handler 410 have adequate control over the pet 402 without compromising on the natural gait of both the handler 410 and the pet dog 402. This is made possible by the multiple degrees of freedom provided by the device 100 through flexible couplings between leash end 304 and distal connector end 256/attachment mechanism 108B/attachment mechanism 108C, between proximal connector end 254//attachment mechanism 108B/attachment mechanism 108C and the ring 234A/234B/pulley frame 242A or 242B, between the ring 234A/234B and the cord guide assembly 106A/106B/106C, between the cord guide assembly 106A/106B/106C and elongated cord body 202 and also between the elongated cord body 202 and the handles 104. All of these flexible couplings collectively let the pet dog 402 and the handler 410 to run in collinear directions without experiencing excessive and/or uneven pulling force. For example, if the pet dog 402 moves sideways with respect to the handler 410, the flexible couplings let the leash end 304 move to the same side as much as possible without requiring the handler 410 to change the direction of arm swing. This is achieved by the flexibility of the couplings including riding of the pulley 246 on the elongated cord body 202 to let the leash end 304 move laterally relative to the handler 410.

For an ideal running experience it is required that the handler 410 and the pet dog 402 come across as less abrupt or uneven forces as possible. But, as the arms of the handler 410 swing during a run, the handles 104A and 104B oscillate back and forth along with the hands 412 and 414. FIG. 5 depicts such an exemplary moment of arm swing where hand 412 of the handler 410 is moving backward and the other hand 414 is at an upswing movement phase. However, at all the phases of the arm swing, the device 100 of the present invention tries to maintain the leash end 304 as steady as possible by allowing the elongated cord body 202 to slide back and forth across the pulley 246 with minimal resistance and also by letting the loops 208 slide freely along the distal part 225 of the handles 104. For example, reference to FIG. 4, when the hands 412 and 414 are almost at a neutral phase of the swinging motion, the leash end 304 can be seen at the front and middle of the handler 410. The same position of the leash end 304 is needed to be maintained even when the hands 412 and 414 are at different positions so that both the pet dog 402 and the handler 410 experience minimal fluctuations of forces. To make this happen, as shown in FIG. 5, the elongated cord body 202 passes through the pulley 246A of the cord guide assembly 106A toward the left hand 414 of the handler 410 and, also, the loop 208B slides down the handle 104B. This way, irrespective of the positions of the hands of the handler 410, the relative movements between the elongated cord body 202 and the cord guide assembly 106A/106B/106C and between the loops 208 and the handles 104 enable the leash end 304 to be maintained at a steady position relative to the handler 410 with minimal resistance. The other flexible couplings also assist in attaining this steady position of the leash end 304.

Sometimes, a user may want to use only one hand to hold a pet leash. One or more fastening elements 228 (shown in FIG. 2B) disposed over the handle body 220 allow for removably attaching the handles 104A and 104B together as shown in FIGS. 6A, 6B and 7. Even in case of such single hand use, the device 100 allows a user to enjoy more freedom in terms of arm movement as the pulley 246 rides over the elongated cord body 202 and the loops 208 slide along the handle 104 to accommodate change in positions of the arm or the pet while maintaining the leash end 304 as steady as possible.

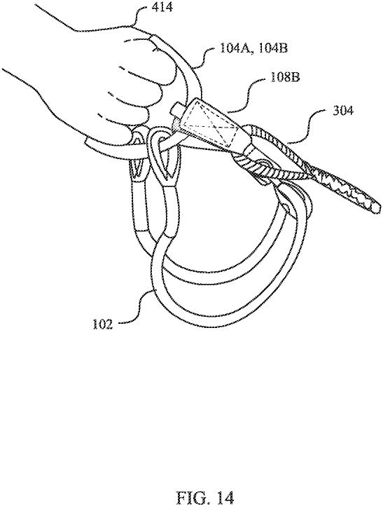

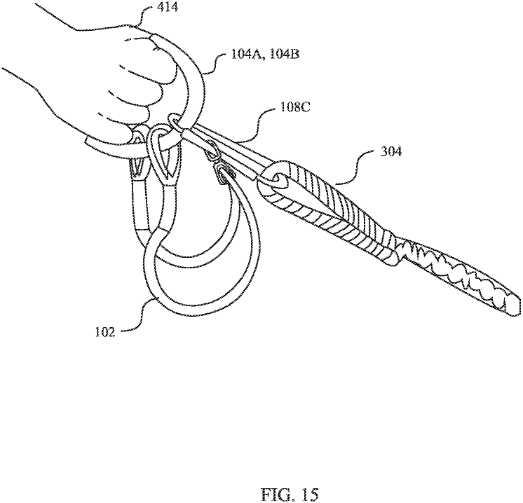

In some instances, to have a tighter control over a pet on leash, a handler may need to hold the pet as close as possible with as less flexibility in the leash as possible. This can be easily achieved with the device 100 by directly connecting the handles 104 to the leash end 304. As shown in FIG. 7, in this arrangement for attachment mechanism 108A, the proximal connector end 254 is coupled to the handles 104 and the distal connector end 256 remains coupled to the leash end 304. FIGS. 14 and 15 illustrate similar arrangements for attachment mechanisms 108B and attachment mechanism 108C. In all of these arrangements, the leash end 304 comes closer to the handler 410 and, as the cord 102 is bypassed, the flexibility otherwise provided by the device 100 also gets reduced. In some embodiments, if required, the distal connector end 256 of attachment mechanism 108A or the attachment mechanism 108B/attachment mechanism 108C can be directly coupled to the collar 404 worn by the pet dog 402 to do away use of leash 302.

Thus, as discussed above, the device 100 of the present invention lets a handler to run with a comfortable and natural arm swinging action while having firm control over a pet on leash running with the handler. Device 100 of the present invention permits the user to position or swing his/her hand(s) in a more natural and comfortable manner without twisting the tendons and muscles in the wrist and forearm. In turn, the stress on the shoulder and back muscles are also diminished.

What is claimed is:

1. A device for running a leashed pet comprising:
a cord having an elongated cord body and a loop disposed at each end of said elongated cord body;
a handle slidably coupled to each of said loop;
a cord guide assembly configured to allow said elongated body run through said cord guide assembly in response to a movement of said handle or of said loop; and
an attachment mechanism configured to releasably receive said cord guide assembly and a portion of a leash.

2. The device as in claim 1, wherein a handle body of said handle defines a graspable gripping portion and an angular portion extending from said graspable gripping portion.

3. The device as in claim 2, wherein said loop is slidable along a distal part of said angular portion.

4. The device as in claim 3, wherein said distal part has a cross-sectional area smaller than a cross-sectional area of rest of said angular portion.

5. The device as in claim 2, wherein said handle further comprises one or more fastening elements disposed over said handle body for removably attaching two of said handles together.

6. The device as in claim 1, wherein said attachment mechanism being further configured to releasably receive said handle.

7. The device as in claim 1, wherein said elongated cord body is adapted to resiliently elongate on application of a force.

8. The device as in claim 2, wherein said angular portion is substantially “D” shaped.

9. The device as in claim 1, wherein said attachment mechanism comprises an elongated connector body having a first part and a second part opposite to said first part, said first part and said second part being configured to be releasably attached to each other.

10. A device for running a leashed pet comprising:
a cord having an elongated cord body and a loop disposed at each end of said elongated cord body;
a handle coupled to each of said loop, said loop and said handle being configured to allow a sliding motion of said loop along a distal part of an angular portion of said handle in response to a movement of said handle or of said loop;
a cord guide assembly configured to ride on said elongated cord body to enable a sliding back and forth motion of said elongated cord body across said cord guide assembly in response to said movement of said handle; and
an attachment mechanism configured to releasably receive said cord guide assembly and a portion of a leash;
wherein, said sliding motion between said handle and said loop, and said sliding back and forth motion of said elongated cord body across said pulley enable said portion of said leash to remain steady relative to said handle during said movement.

11. The device as in claim 10, wherein said angular portion is substantially “D” shaped.

12. The device as in claim 10, wherein said handle further comprises one or more fastening elements disposed over said handle body for removably attaching two of said handles together.

13. The device as in claim 10, wherein said proximal connector end being further configured to releasably receive said handle.

14. The device as in claim 10, wherein said distal part has a cross-sectional area smaller than a cross-sectional area of rest of said angular portion.

15. The device as in claim 10, wherein said angular portion extends from a graspable gripping portion of said handle.
